(19) United States
(12) Patent Application Publication
(10) Pub. No.: US 2004/0195519 A1
(43) Pub. Date: Oct. 7, 2004

(54) In vitro method of determining the protection efficacy of a substance against solar radiation

(76) Inventors: Jean-Louis Refregier, Conflans Ste Honorine (FR); Alain Chardon, Paris (FR)

Correspondence Address: Jay A. Bondell, Esq., SCHWEITZER CORNMAN GROSS & BONDELL LLP, 292 Madison Avenue, New York, NY, 10017, US

(21) Appl. No.: 10/773,553

(22) Filed: Feb. 5, 2004

(30) Foreign Application Priority Data
Jun. 11, 2003 (FR) 03 06983

(51) Int. Cl. G01J 1/42

(52) U.S. Cl. 250/372

(57) ABSTRACT

The present invention provides an in vitro method of determining the protection efficacy of a substance against a cutaneous photobiological phenomenon caused by exposure to solar radiation. The photobiological phenomenon has an action spectrum S(λ). The method comprises determining a dynamic absorption spectrum DO(λ,t) representing the variation in the absorption spectrum of the substance as a function of duration of exposure to a source of radiation emitting in the ultraviolet, and calculating the protection efficacy of the substance against the photobiological phenomenon on the basis of the dynamic absorption spectrum.

This application claims the benefit of French Application No. 03 06983 filed on Jun. 11, 2003, the disclosure of which is incorporated by reference herein.

The present invention relates to an in vitro method of determining the protection efficacy of a substance against solar radiation, and in particular against A-band ultraviolet radiation (UVA).

Knowledge of the absorption spectrum DO(λ) of a substance spread in the form of a thin layer on a substrate that is inert relative to the substance is useful for in vitro determination of the protection factor of the substance against a predetermined phenomenon of cutaneous photobiological damage of known action spectrum, e.g. erythema, as proposed in 1989 by B. Diffey (B. L. Diffey, J. Robson, A new substrate to measure sunscreen protection factors throughout the ultraviolet spectrum, J Soc Cosmet Chem 40, 127-133, 1989).

Nevertheless, those calculations are based on an instantaneous evaluation of the absorption spectrum of the substances, and consequently they can be applicable only providing the absorption spectrum remains accurately constant throughout exposure to solar radiation.

Unfortunately, under the effect of the energy transmitted by solar radiation, certain sunscreens can become transformed into new chemical entities with capacity to absorb solar radiation that is different from that of the starting substance. Under such circumstances, the equation proposed by B. Diffey which consists merely in a static ratio of flux densities, can consequently cease to be applicable.

There exists a need to benefit from a specific in vitro method of evaluation of protection efficacy, in particular against UVA, which takes account of the photo-chemical behavior of the substance while it is exposed to solar radiation.

In addition, the sun protection factor (SPF) as determined in vivo by the May 1994 COLIPA method provides information essentially on the ability of the substance to provide protection against B-band UV radiation (UVB) during exposure. Unfortunately, UVA (320 nanometers (nm) to 400 nm) is considered as contributing in non-negligible manner to skin aging.

European patent application EP 1291640 A1 describes an in vitro method of determining the protection efficacy of a substance against UVA.

That method does not make it possible to determine in precise manner the protection efficacy of a substance that is photo-unstable.

Consequently, there exists a need for a reliable method enabling a protection factor to be determined that is specific against UVA, and that takes account of possible variation in the screening ability of the substance under investigation during exposure to solar radiation.

A particular object of the invention is to satisfy at least one of those needs.

Thus, in one of its aspects, the invention provides an in vitro method of determining the protection efficacy of a substance against a cutaneous photobiological phenomenon caused by exposure to solar radiation, said photobiological phenomenon having an action spectrum S(λ), the method being characterizable by the fact that it comprises the step consisting in determining a dynamic absorption spectrum DO(λ,t) representing the variation in the absorption spectrum of the substance as a function of duration of exposure to a source of radiation emitting in the ultraviolet, and in calculating the protection efficacy of the substance against said photobiological phenomenon on the basis of said dynamic absorption spectrum.

By way of example, the action spectrum S(λ) may be the action spectrum E(λ) of erythema or P(λ) of persistent pigment darkening (PPD).

In an implementation of the invention, protection efficacy is determined by the ratio:

$$\frac{{\int }_{t}^{} {\int }_{λ}^{} S ( λ ) \cdot I ( λ ) \cdot ⅆ λ \cdot ⅆ t}{{\int }_{t}^{} {\int }_{λ}^{} S ( λ ) \cdot I ( λ ) \cdot {10}^{- c \cdot D0 ( λ , t )} \cdot ⅆ λ \cdot ⅆ t}$$

where I(λ) designates the spectral flux density received from the source by the sample under test and c designates a constant which can be adjusted to make the calculated magnitude correspond to a magnitude measured in vivo.

The constant c can thus be calculated in such a manner that the magnitude

$${SPF}_{r} = \frac{{\int }_{t = 0}^{{t}_{max}} {\int }_{λ = 290 nm}^{400 nm} E ( λ ) \cdot I ( λ ) \cdot ⅆ λ \cdot ⅆ t}{{\int }_{t = 0}^{{t}_{max}} {\int }_{λ = 290 nm}^{400 nm} E ( λ ) \cdot I ( λ ) \cdot {10}^{- c \cdot D0 ( λ , t )} \cdot ⅆ λ \cdot ⅆ t}$$

is equal to the in vivo SPF, where tₘₐₓ is the time needed for the transmitted erythemal dose to be equal to the minimum erythemal dose (DEM), and where E(λ) is the action spectrum of erythema as defined in particular in Commission Internatonale de l'Eclairage (CIE): A reference action spectrum for ultraviolet erythema in human skin. CIE Research Note No. 6, 17-22, 1987.

To determine the dynamic absorption spectrum DO(λ,t), it is possible to measure the absorption spectrum DO(λ,t) after different durations t of exposure to the UV source, and the absorption spectra DO(λ,t) can be adjusted relative to one another so as to make the optical densities DO(λ′,t) equal for a particular wavelength value λ′, where λ′<290 nm.

λ′ may lie in the range 250 nm to 280 nm, e.g. being equal to 260 nm or 270 nm.

As mentioned above, the action spectrum S(λ) may be that for persistent pigment darkening P(λ) and a resulting protection factor APRᵣ against UVA can be calculated using the formula:

$${APF}_{r} = \frac{{\int }_{t = 0}^{t = k \cdot {t}_{max}} {\int }_{λ = 320 nm}^{400 nm} P ( λ ) \cdot I ( λ ) \cdot ⅆ λ \cdot ⅆ t}{{\int }_{t = 0}^{t = k \cdot {t}_{max}} {\int }_{λ = 320 nm}^{400 nm} P ( λ ) \cdot I ( λ ) \cdot {10}^{- c \cdot D0 ( λ , t )} \cdot ⅆ λ \cdot ⅆ t}$$

where k is a non-zero constant which may lie in the range 0.5 to 3, for example.

P(λ) is defined in particular in D. Moyal, A. Chardon, N. Kollias: UVA protection efficacy of sunscreens can be determined by the persistent pigment darkening (PPD) method (Part 2). Photodermatol Photo-immunol Photomed, 16, 250-255, 2000.

In another of its aspects, the invention also provides a method of determining the dynamic absorption spectrum DO(λ,t) of a photosensitive substance for which it is desired to determine the protection efficacy against a cutaneous biological phenomenon, said photo-biological phenomenon having an action spectrum S(λ), in which method, the absorption spectrum DO(λ,t) is measured after different durations t of exposure to a UV source of constant flux density, and the absorption spectra DO(λ,t) are adjusted amongst one another in such a manner as to make the optical densities DO(λ′,t) equal for a particular wavelength value λ′, with λ′<290 nm.

λ′ may lie in the range 250 nm to 280 nm, and is preferably equal to 260 nm or 270 nm.

The invention also provides a method of promoting the sale of a sunscreen product, which method comprises the step consisting in specifying an efficacy of the product, in particular against UVA, as determined by a method as defined above.

By way of example, such promotion may appear on packaging associated with the product or on any other communications channel, e.g. by radio, TV, or poster advertising, or on a telephone or computer network.

The invention can be better understood on reading the following detailed description of non-limiting implementations thereof, and on examining the accompanying drawings, in which;

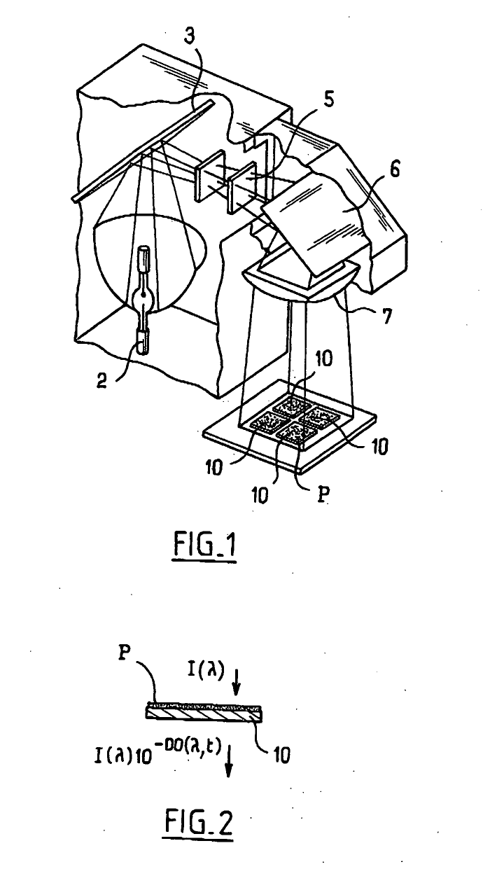

FIG. 1 is a fragmentary and diagrammatic view of an example of solar radiation simulator for exposing a substance to increasing doses of ultraviolet radiation with constant flux density so that the applied doses can, in practice, be strictly proportional to exposure time, prior to measuring the absorption spectrum of the substance;

FIG. 2 is a fragmentary and diagrammatic section view of a substrate on which the substance for testing has been spread;

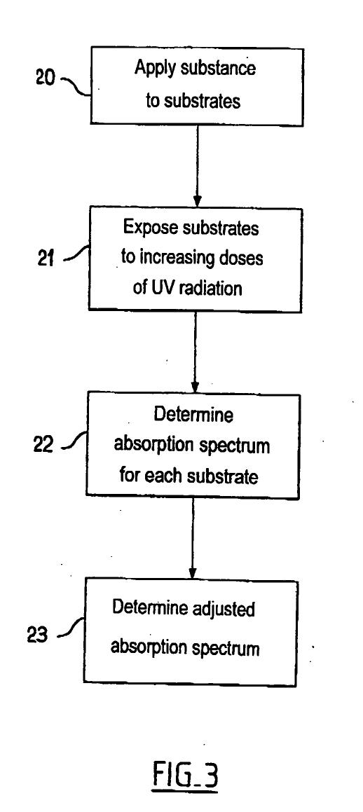

FIG. 3 is a block diagram showing various steps in determining a dynamic absorption spectrum DO(λ,t);

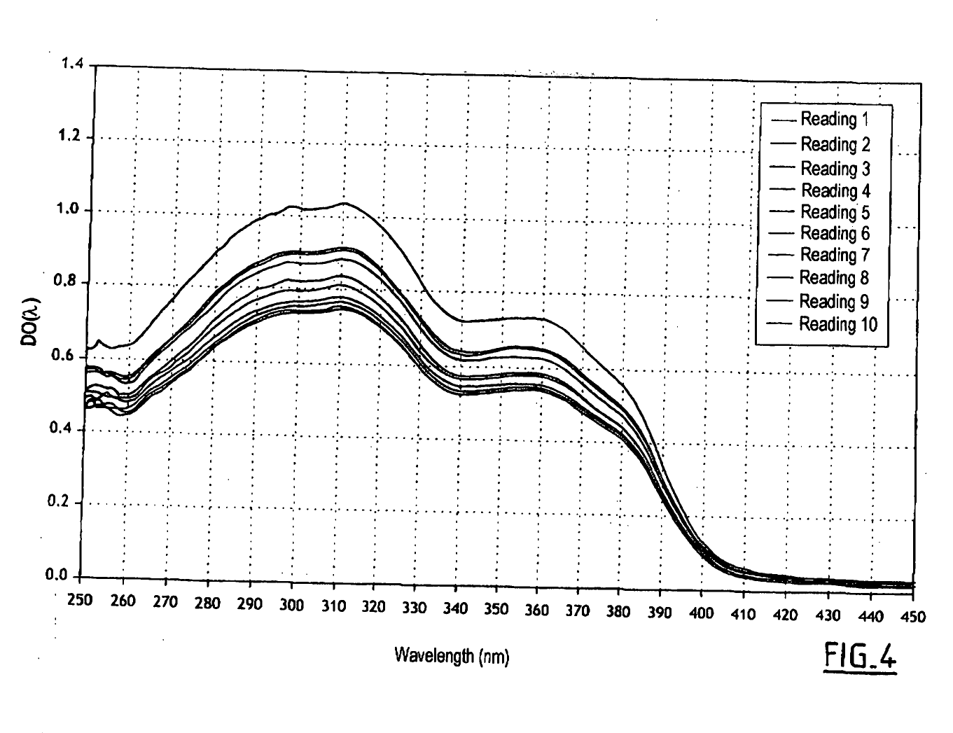

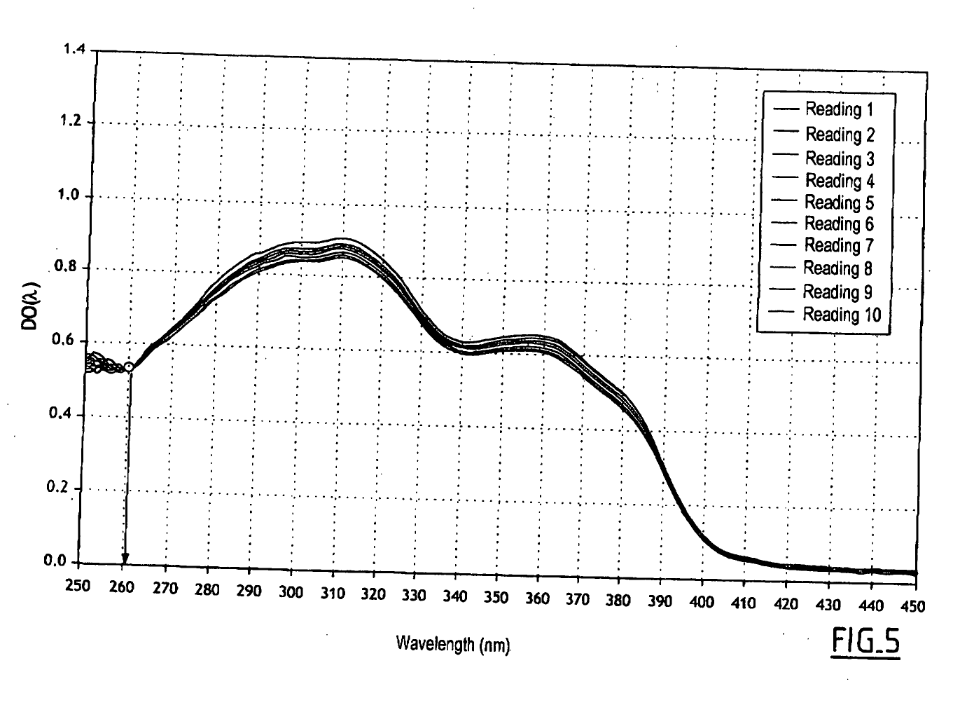

FIG. 4 is a graph plotting curves of optical density DO(λ) as measured at different points on a substrate;

FIG. 5 is a graph plotting the absorption spectrum DO(λ) of the substance after the various curves of FIG. 4 have been adjusted;

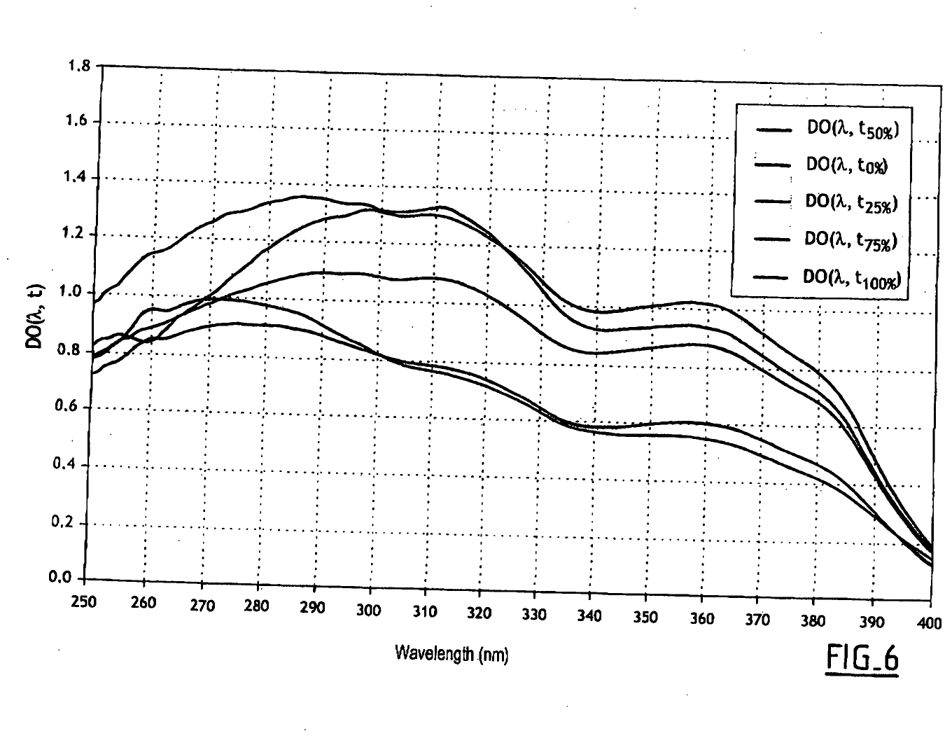

FIG. 6 is a graph plotting different absorption spectra corresponding to respective increasing durations of exposure;

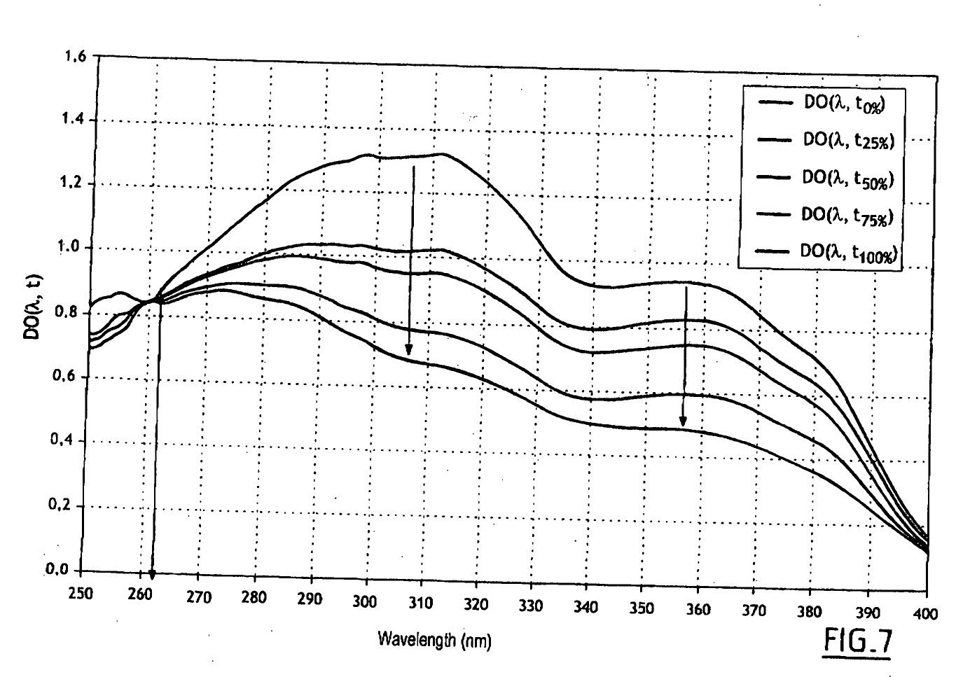

FIG. 7 shows the absorption spectra of FIG. 6 after they have been adjusted;

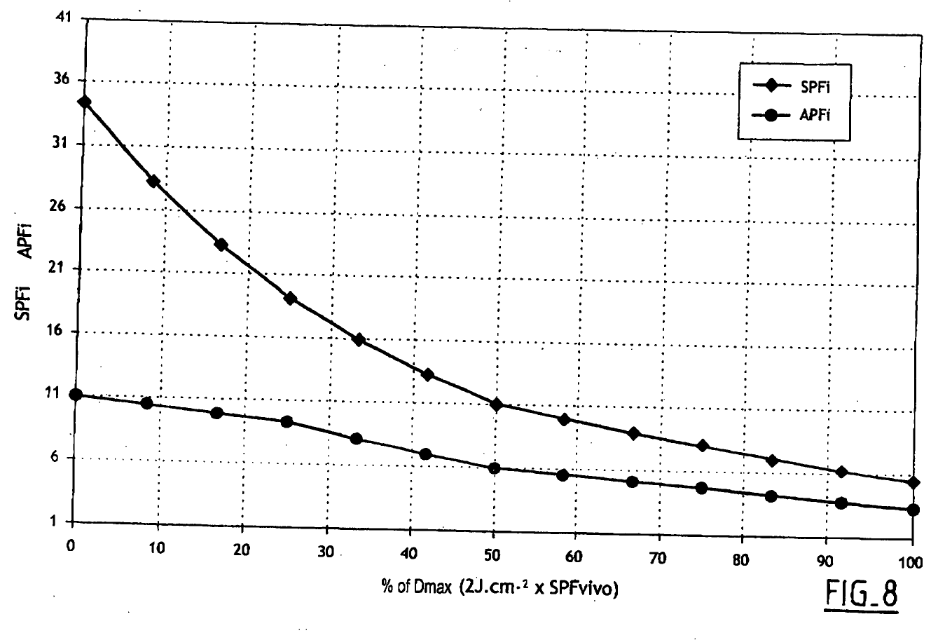

FIG. 8 shows an example of how the instantaneous sun protection factor SPFᵢ and the instantaneous UV protection factor APFᵢ vary as a function of the applied dose of ultraviolet radiation; and

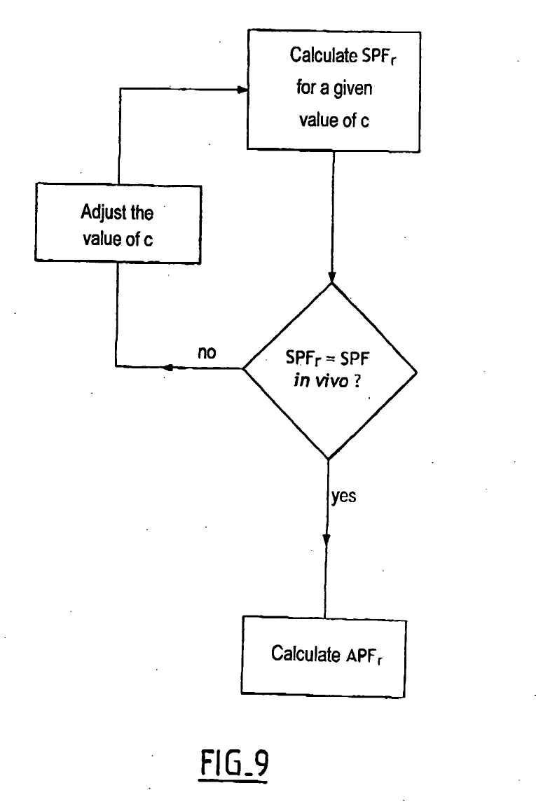

FIG. 9 is a block diagram showing the steps in calculating the protection facto APFᵣ.

To determine the protection efficacy of a sunscreen in vitro, use is made of a source that emits in the ultraviolet.

This source may be sold under the ORIEL trademark and may comprise, as shown in FIG. 1, a short-arc xenon lamp 2, a dichroic mirror 3, and a filter system 5.

A mirror 6 is used to send the light to a lens 7 so as to illuminate substrates 10, one of which is shown in isolation in FIG. 2, each of these substrates being coated on one face in a layer of the substance P whose protection efficacy against solar radiation is to be determined.

Depending on the desired spectral flux density I(λ), various different filter systems 5 can be used.

For example, a WG320 filter from the supplier SCHOTT having a thickness of 1 millimeter (mm) can be used to obtain a so-called “SSR” source (UVB+UVA, 290 nm-400 nm) used for in vivo determination of SPF (Colipa's 1994 SPF method). A 3 mm thick WG335 filter may be used for obtaining flux in the UVA spectrum (320 nm-400 nm) in compliance with the in vivo PPD method as described in the following articles: A. Chardon, D. Moyal, C. Hourseau: Persistent pigment darkening response as a method for evaluation of UVA protection assays published in “Sunscreens: development, evaluation and regulatory aspects”, 2nd edition (N. Lowe, N. Shath, M. Pathak, ed.; Marcel Dekker Inc.), pp. 559-582, 1986, and D. Moyal, A. Chardon, N. Kollias: UVA protection efficacy of sunscreens can be determined by the persistent pigment darkening (PPD) method (Part 2), published in Photo-dermatol Photoimmnol Photomed, 16, 250-255, 2000.

Naturally, other filter systems 5 can be used, depending on the desired exposure spectrum.

In the example described, the substrates 10 are constituted by plates of polymethylmethacrylate (PMMA), e.g. in square format having a side of 50 mm and a thickness of 2.5 mm. Each substrate 10 may present a frosted face, e.g. obtained by sandblasting with sand having grain size lying in the range 90 micrometers (μm) to 150 μm at a pressure of 6 bars, and at a range of 30 centimeters (cm), with the substance P subsequently being deposited thereon.

Naturally, the invention can be implemented using other substrates 10 that present sufficient transparency in the UV range (250 nm to 400 nm).

The substance P may be applied at a concentration of 0.75 milligrams per square centimeter (mg.cm⁻²), for example, on each substrate 10, corresponding to step 20 in FIG. 2. The quantity of substance applied is determined so that without exposure to UV, the calculated static SPF is close to the in vivo SPF of the substance under investigation. Care is also taken to ensure that the dynamic range of the response of the apparatus for measuring optical densities DO(λ,t) is sufficient to avoid becoming saturated.

In the implementation described, the UV source is used to expose the substance P deposited on the substrates 10 to respective increasing doses D₀%, D₂₅%, D₅₀%, D₇₅%, and D₁₀₀% as shown in step 21 of FIG. 3. These doses correspond, for example, respectively to 0%, 25%, 50%, 75%, and 100% of a maximum dose Dₘₐₓ as defined below.

To obtain such doses, the substrates 10 are exposed during respective increasing durations t₀%, t₂₅%, t₅₀%, t₇₅%, and t₁₀₀%, with the spectral flux density I(λ) of the source remaining constant over time at the surface of the substrates. The overall flux density of the UV source at the substrates is monitored by a flat UVA sensor, e.g. under the trademark SOLAR-LIGHT Co., referenced PMA2110F, and a radiometer of reference PMA2100 previously calibrated by spectroradiometry under each of the spectra of the UV source used, using the protocol recommended by the following documents: F. Christiaens, A. Chardon: Calibration of UV light meters is needed to guarantee the relevance of measurements, in Poster P1772 WCD (Paris), Jul. 1-5, 2002; 5th Workshop on UVR Measurements (Poster), Kassandra, Halkidiki (Greece), Oct. 7-8, 2000; and Colipa project team 3: Standard operating procedure (SOP) for UV source monitoring, Final draft, April 2003.

When the substance P is photo-unstable, photo-chemical modifications take place during exposure, thereby leading to a modification in its absorption spectrum.

After exposure to the UV source, the absorption spectrum of the substance P deposited on each substrate 10 is measured, which corresponds to step 22.

This measurement of the absorption spectrum is preferably performed at a plurality of points on the corresponding substrate 10, e.g. about ten points distributed regularly over the substrate 10. This makes it possible to minimize the influence of local variations in the thickness of the substance.

After passing through the substance P present on the substrate 10, the spectral flux density I(λ) is compared with the incident radiance, thus making it possible by logarithmic transformation to define the spectral optical density DO(λ). The optical density DO(λ) can be measured in conventional manner by means of a spectrum analyzer sweeping the minimum spectrum band 250 nm to 450 nm in steps having a maximum size of 1 nm and with a minimum dynamic range corresponding to two optical density units DO over the entire band, e.g. an analyzer sold under the trademark LABSPHERE, and referenced UV1000S.

FIG. 4 shows the absorption spectra DO(λ) for a given substrate 10, as measured at different points thereon.

To correct for the differences observed between the different curves due to local variations in the thickness of the substance, the curves are adjusted at a particular wavelength, equal to 260 nm in the example described.

The adjustment consists in taking the optical density, e.g. at 260 nm, of one of the curves as a reference value, and in multiplying the optical density of the other curves over the entire spectrum by the quantity DO_{curve to be adjusted} (260 nm)/DO_{reference curve} (260 nm)

The arithmetic mean of the curves as adjusted in this way can be calculated and subsequently taken as corresponding to the absorption spectrum of the substance that has been subjected to prior exposure for a determined duration t at constant flux density received from the source UV.

Once the absorption spectrum has been determined for each substrate 10, a dynamic optical density DO(λ,t) can be established, as shown in FIG. 6.

This figure shows the various absorption spectra obtained after exposing the substance to durations t corresponding respectively to 0%, 25%, 50%, 75%, and 100% of the maximum exposure duration tₘₐₓ.

In the example described, this maximum duration tₘₐₓ is the duration required for applying the dose Dₘₐₓ.

In order to take account of the fact that the thicknesses of substance applied to each of the substrates 10 are not rigorously identical, it is advantageous to adjust the dynamic optical density, which corresponds to step 23 in FIG. 3.

The adjustment is performed by taking one of the absorption spectra DO(λ,t_{0%}), DO(λ,t_{25%}), DO(λ,t_{50%}), DO(λ,t_{75%}), DO(λ,t_{100%}) as a reference curve, referred to below as DO(λ, t_{ref}).

Thereafter, the optical density of each of the other curves is multiplied by the quantity DO(λ′,t)/DO(λ′,t_{ref}), where λ′ is advantageously selected to be equal to 260 nm or to 270 nm, i.e. outside that portion of the spectrum in which the substance is to provide protection, and where SPRᵣ is calculated over the range 290 nm to 400 nm. In this respect, a value for λ′ of less than 290 nm is therefore preferred.

After adjustment, a set of curves is obtained as shown in FIG. 7, considered below as corresponding to the dynamic absorption spectrum DO(λ,t).

The instantaneous protection factor SPFᵢ of the substance after being exposed for a duration t to the constant flux density received from the source UV may be calculated using the following formula:

$${SPF}_{i} ( t ) = \frac{{\int }_{λ = 290 nm}^{400 nm} E ( λ ) \cdot I ( λ ) \cdot ⅆ λ}{{\int }_{λ = 290 nm}^{400 nm} E ( λ ) \cdot I ( λ ) \cdot {10}^{- c \cdot D0 ( λ , t )} \cdot ⅆ λ}$$

and the instantaneous protection factor against UVA can be calculated using the following formula:

$${APF}_{i} ( t ) = \frac{{\int }_{λ = 320 nm}^{400 nm} P ( λ ) \cdot I ( λ ) \cdot ⅆ λ}{{\int }_{λ = 320 nm}^{400 nm} P ( λ ) \cdot I ( λ ) \cdot {10}^{- c \cdot D0 ( λ , t )} \cdot ⅆ λ}$$

where E(λ) is the action spectrum for erythema, P(λ) is the action spectrum for persistent pigment darkening, and where c is a constant.

In FIG. 8, it can be seen that these instantaneous protection factors decrease as a function of time for a photo-unstable substance, which means that the substance loses efficacy.

The resulting dynamic protection factor SPFᵣ can be determined by the ratio of the applied total erythemal dose to the transmitted total erythemal dose, i.e. the ratio of the integrals of the individual applied and transmitted erythemal doses in the wavelength band 290 nm to 400 nm and over the duration tₘₐₓ, by using the following formula:

$${SPF}_{r} = \frac{{\int }_{t = 0}^{{t}_{max}} {\int }_{λ = 290 nm}^{400 nm} E ( λ ) \cdot I ( λ ) \cdot ⅆ λ \cdot ⅆ t}{{\int }_{t = 0}^{{t}_{max}} {\int }_{λ = 290 nm}^{400 nm} E ( λ ) \cdot I ( λ ) \cdot {10}^{- c \cdot D0 ( λ , t )} \cdot ⅆ λ \cdot ⅆ t}$$

In an implementation of the invention, the duration tₘₐₓ may correspond to the duration needed for the transmitted dose to be equal to the minimum erythemal dose written DEM, whose standard value needs to be fixed beforehand, e.g. 210 J.m⁻².ery and 20 kJ.m⁻² UVA under the SSR spectrum. To calculate the integrals, the value of DO(λ,t) may be calculated by interpolation for each value of λ from the known values.

When the source delivers flux of the SSR type, the dose Dₘₐₓ, and consequently the duration tₘₐₓ can be determined by the formula Dₘₐₓ=SFP.20 kilojoules per square meter (kJ.m⁻²).

In a variant, the quantity Dₘₐₓ may be taken as being equal to a value lying, for example, in the range 50% to 200% of the UVA dose received during in vivo determination of the SPF of the substance under consideration.

The constant c can be adjusted by the iterative procedure of FIG. 9 so that the resulting factor SPFᵣ is equal to the SPF factor as determined in vivo.

Once the constant c has been determined, the protection factor APFᵣ representing the protection given by the substance against UVA can be determined by the following formula:

$${APF}_{r} = \frac{{\int }_{t = 0}^{t = k \cdot {t}_{max}} {\int }_{λ = 320 nm}^{400 nm} P ( λ ) \cdot I ( λ ) \cdot ⅆ λ \cdot ⅆ t}{{\int }_{t = 0}^{t = k \cdot {t}_{max}} {\int }_{λ = 320 nm}^{400 nm} P ( λ ) \cdot I ( λ ) \cdot {10}^{- c \cdot D0 ( λ , t )} \cdot ⅆ λ \cdot ⅆ t}$$

where P(λ) is the action spectrum of persistent pigment darkening, used in the PPD method.

The exposure duration tₘₐₓ taken into account for calculating the magnitude APFᵣ and the corresponding maximum ultraviolet dose as applied may be greater than for calculating the magnitude of SPFᵣ. This possibility is expressed by introducing a factor k for calculating the maximum applied dose taken into account for calculating APFᵣ relative to the maximum applied dose used for calculating SPFᵣ.

Naturally, the invention is not limited to the implementations described above.

The substrates 10 may be replaced by a single substrate subjected to an accumulation of successive exposures to irradiation, with spectral optical density being measured after each partial irradiation.

The in vivo SPF may also be determined by the Harmonized International SPF Method 2003.

Throughout the description, including in the claims, the term “comprising a” should be understood as being synonymous with “comprising at least one” unless specified to the contrary.

The term “lying in the range” should be understood as including the end values.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An in vitro method of determining the protection efficacy of a substance (P) against a cutaneous photobiological phenomenon caused by exposure to solar radiation, said photobiological phenomenon having an action spectrum S(λ), the method comprising determining a dynamic absorption spectrum DO(λ,t) representing the variation in the absorption spectrum of the substance as a function of duration of exposure to a source of radiation emitting in the ultraviolet, and calculating the protection efficacy of the substance against said photobiological phenomenon on the basis of said dynamic absorption spectrum.
